(19) United States
(12) Patent Application Publication
(10) Pub. No.: US 2024/0396724 A1
(43) Pub. Date: Nov. 28, 2024

(54) METHOD FOR KEY GENERATION USING PHYSICALLY UNCLONABLE FUNCTIONS

(71) Applicant: CARNEGIE MELLON UNIVERSITY, Pittsburgh, PA (US)

(72) Inventors: Md. Sakibur Rahman Sajal, Pittsburgh, PA (US); Marc Dandin, Allison Park, PA (US)

(73) Assignee: CARNEGIE MELLON UNIVERSITY, Pittsburgh, PA (US)

(21) Appl. No.: 18/672,716

(22) Filed: May 23, 2024

Related U.S. Application Data
(60) Provisional application No. 63/468,434, filed on May 23, 2023.
(60) Provisional application No. 63/468,441, filed on May 23, 2023.

(51) Int. Cl. H04L 9/08; H04L 9/32

(52) U.S. Cl. CPC H04L 9/0866; H04L 9/3278

(57) ABSTRACT

Disclosed herein is a method for determining a physically unclonable function of a pixel array using the dark count rate of events at each pixel to form a dark count map. The dark count map serves as a signature of the array from which a set of authentication keys may be generated to provide verification of images generated by the pixel array. Multiple dark count maps from which multiple key sets can be generated may be provided for the pixel array by varying the perimeter gate voltage of each pixel.

### RELATED APPLICATIONS

This application claims the benefit of U.S. Provisional Patent Applications Nos. 63/468,434 and 63/468,441, both filed May 23, 2023, the contents of which are incorporated herein in their entireties.

### BACKGROUND OF THE INVENTION

A physically unclonable function (PUF) is a structural feature of a chip, imparted by process and manufacturing variations. PUFs rely on variations inherent in the silicon manufacturing process to provide unique signatures from chip to chip. These signatures cannot be predicted and cannot be reproduced. Therefore, they can be used for generating authentication keys that are chip-specific and non-reproducible.

In traditional applications, authentication keys are stored within a device and retrieved prior to the device being authenticated. However, with the advent of interconnected devices and the Internet of Things (IoT), peripheral hardware devices have become vulnerable to tampering, particularly to attempts of impersonating trusted devices. As such, PUFs help by eliminating the need to store keys physically. Rather, leveraging the device's PUF, authentication keys can be generated on the fly in response to a known challenge, thus creating what is known as a challenge-response pair (CRP) that can be used for authentication.

Example implementations of silicon PUFs include arbiter chains, ring-oscillators and memory circuits. In each case, variations inherent in the manufacturing process impart a key signature to these circuits, making them suitable for generating unique and device-specific keys.

Recently, CMOS image sensor chips have become ubiquitous, and they too have been studied as a means of generating authentication keys from PUFs. In one example the reset voltage variation from pixel pairs of a CMOS image sensor is exploited to generate a unique and reliable binary signature. In another example, a PUF was based on an imager's column fixed pattern noise (CFPN). In yet another example, an imager PUF was implemented based on photo-response non-uniformity (PRNU).

While these approaches are notable, they are not readily applicable to cameras that operate in Geiger mode (i.e., in cameras configured for high-speed imaging based on light quanta and for photon counting).

An additional issue is the size of the CRP space. The size of the CRP space determines the strength of the PUF. In conventional CMOS imager-based PUFs, a challenge vector may be a set of pixel addresses and a response may be a vector of measurement values at each pixel in the challenge vector. For example, the measurements may be the reset voltages at each pixel. In this example, although the number of possible challenges scales with pixel array size, the actual number of CRPs is limited.

For instance, consider a scheme where responses from two adjacent pixels are compared to generate a key bit. Once the two pixels are compared, they cannot be used in another challenge since the outcome of the comparison will always yield the same key bit value. Hence, in such a scheme, the CRP space is limited to n/2, where n is an even number representing the total number of available pixels in the array.

### SUMMARY OF THE INVENTION

Disclosed herein is a strategy for developing PUFs for Geiger mode imager pixel arrays and generating authentication keys using the PUFs. In the exemplary embodiments disclosed herein, a custom-designed Geiger mode camera implemented from a pixel array of perimeter-gated single photon avalanche diodes (pg-SPADs) is used. In an exemplary embodiment of the invention, a method is disclosed for using the imager's PUF as a viable authentication key generator by making use of the imagers' dark count maps (DCMs), which are signatures unique to each individual pixel array from which unique authentication keys can be generated.

The keys generated from the DCMs have a high inter-chip normalized Hamming distance (nHD) for the same challenge, showing that unique keys can be generated from each sensor. The intra-chip nHD between different keys from different challenges is sizable, allowing a large number of distinct CRPs to be generated from the same chip. For example, the number of distinct m-bit challenges from a sensor of N pixels is PN, where P is the number of possible permutations. Using a strategy disclosed herein, the responses can be made resilient to changes in temperature. Further, the ability of perimeter gating to modulate the dark count rate (DCR) at the single pixel level serves to change or conceal the imager's PUF, thereby providing an additional security feature.

In a second aspect of the invention, disclosed herein is a novel method for increasing the CRP space of the pg-SPAD based PUF. Specifically, the perimeter gating voltage may be used to dynamically alter the PUF and thus increase the number of unique challenge-response pairs. This method overcomes the typical size limitations of the CRP space of conventional CMOS imager-based PUFs.

### BRIEF DESCRIPTION OF THE DRAWINGS

FIG. 1 is a circuit diagram shown an exemplary pg-SPAD pixel architecture.

FIG. 2 is a higher-level schematic showing the AQAR function.

FIG. 3 is a flowchart showing the process for collecting the DCRs for each pixel, forming the DCM.

FIG. 4 is a timing diagram of the pg-SPAD showing the challenge-response pair formation.

FIG. 5 is a flowchart showing the process for generating binary fingerprints from normalized dark count maps.

FIG. 6 is a flowchart showing the response generation in response to a challenge.

FIG. 7 illustrates the effect of temperature on the normalized dark count maps of several perimeter-gated imagers.

FIG. 8 is a graph showing the distribution of normalized Hamming distances for key pairs from the same chip as a function of key bit-lengths.

FIG. 9 are graphs showing key resilience to temperature changes for key populations generated from the same chip.

FIG. 10 is a comparison of three prototype chips showing variations in the structural similarity, the dark counts and the altered dark count distributions from varying the perimeter gating voltage.

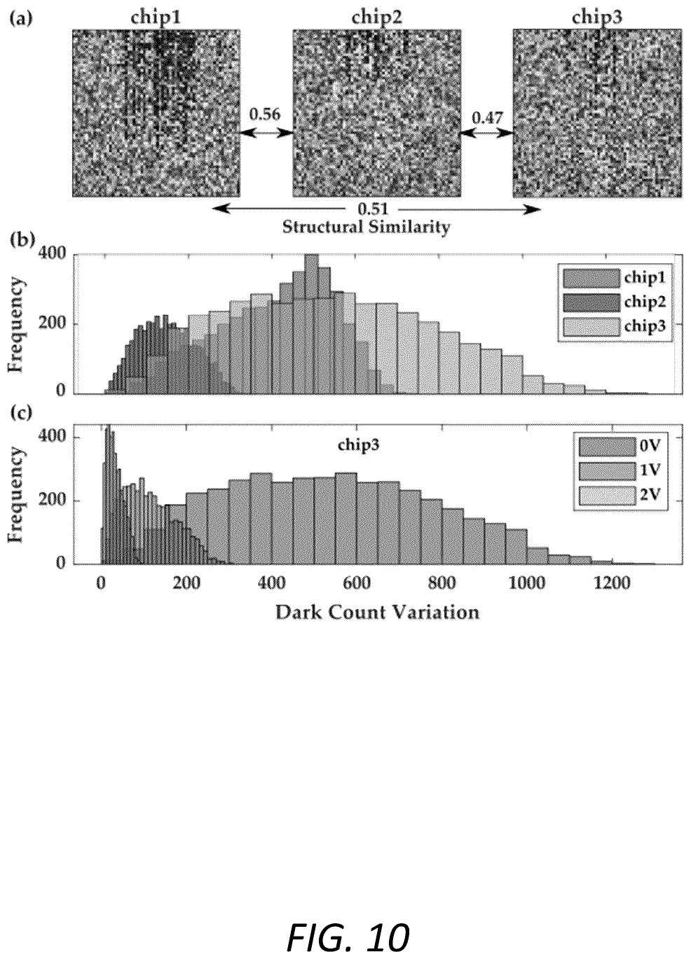

FIG. 11 is a flowchart showing is a flowchart showing the process for collecting the DCRs for each pixel, wherein the perimeter gate voltage is varied on a pixel-by-pixel basis.

FIG. 12 shows histograms of the Hamming distance between keys with and without PUF reconfiguration by variance of the perimeter gate voltage.

### DETAILED DESCRIPTION

Disclosed herein is a system and method for using the physically unclonable functions of a Geiger mode photo imager to generate device-specific signatures that can be used to generate keys for verifying images collected using the photo imager. Signatures can be provided as image meta-data or integrated into the image itself and can be used to verify that the image was generated by a specific pixel array or that the image is unaltered.

The invention will be explained in the context of a photo imager comprising a pixel array wherein each constitutive pixel is implemented using a perimeter-gated single photon avalanche diode, referred to herein as a pg-SPAD. SPADs are photodiodes structurally designed for operation above their nominal breakdown voltage. In that regime, they are sensitive to single photons. A single photon may generate an electron hole pair that can initiate an avalanche of carriers, yielding a sharp rise in current through the device. Thus, a SPAD pixel may operate as a photon counter by sensing the current's rising edge and immediately quenching and resetting the pixel to detect another photon. As may be realized, the invention is not meant to be limited to embodiments using a pg-SPAD but is useful in any pixel array capable of generating a dark count map, as will be explained later herein.

An exemplary chip-on-board perimeter-gated photo imager is 5 mm×5 mm and features a 64×64 pg-SPAD array with peripheral circuits for control and readout. Each pg-SPAD is provided with in-pixel circuitry for sensing avalanche events.

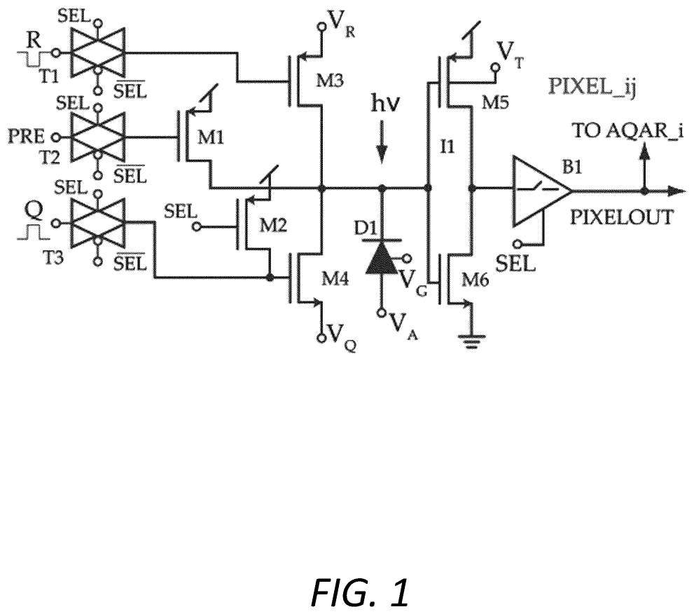

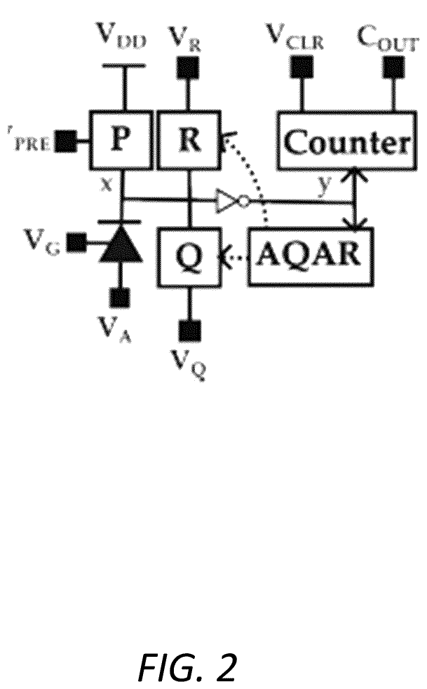

The operation of the pg-SPAD pixel will be explained as a pretext to an explanation of the invention. A circuit diagram of an exemplary pg-SPAD of the type with which the invention may be used is shown in FIG. 1. An imager may comprise, in one embodiment 4,096 pixels disposed in a 64×64 array. Each pixel comprises a pg-SPAD, access circuits for pixel selection and pre-charging (T1, T2, T3, M1, and M2), active quenching (M4) and active reset (M3) transistors, and an avalanche sensing circuit formed using an inverter (I1) and a tri-state output buffer (B1). Active quenching and active reset signals (Q and R, respectively) are generated off-pixel using an active quenching/active reset (AQAR) circuit, as shown in FIG. 2, which takes as its input the output of the pixel (PIXELOUT).

The pg-SPAD is a three terminal avalanche diode biased above its nominal breakdown voltage, that is, operating in Geiger mode. In that regime, a single photogenerated carrier can generate a sustained avalanche current which is then quenched using active quenching transistor M4 in response to quenching signal Q.

The sensing circuit (I1, B1) detects the avalanche current and creates a digital signal (PIXELOUT) whose leading edge corresponds to the onset of avalanche. This signal is fed to an output counter, whose value is read after a set integration time for the measurement. After quenching, the pg-SPAD is reset via transistor M3, in response to a reset signal R and the pg-SPAD is thus ready for detecting another event.

Signals for quenching the avalanche current and resetting the pg-SPAD are generated off-pixel using the active quenching active-reset (AQAR) logic circuit. The pg-SPAD's third terminal (i.e., its perimeter gate, VG) serves to curtail premature edge breakdown and ensure proper Geiger mode operation.

Avalanche events may be triggered by thermally generated carriers and by carrier emission processes originating from band-to-band tunnelling or carrier release from trap states. The occurrence rate of these counts during a measurement period is referred to herein as the pixel's dark count rate (DCR).

In the pg-SPAD imager described herein, manufacturing process variations cause pixel-to-pixel variations in the DCR, giving rise to a DCR pattern that is distinctive from chip to chip. This pattern is referred to herein as the dark signal non-uniformity (DSNU). The DSNU is used as the underlying PUF fingerprint from which keys are generated. Additionally, the perimeter gate voltage is used to alter the PUF to enhance the CRP space, as discussed below in a description of a second aspect of the invention.

Perimeter gating of SPADs has been shown as a structural technique for actively reducing the DCR of a SPAD pixel. Specifically, a perimeter gate surrounds the pixel, and when energized, it modulates the spatial carrier distribution within the diode such that the avalanche is confined to the volumetric metallurgical junction. The net effect is a reduction in pixel DCR, allowing high-SNR operation at low light fluxes. At high perimeter gate voltage magnitudes, the DCR may be reduced to zero for relatively short pixel integration times. In other words, with a combination of gate voltage and integration time, the DCR of each pixel may be reduced to zero. In that regime, the device may still detect photons, thereby allowing high-SNR phototransduction. Empirically, when the perimeter gate voltage of the particular pg-SPAD shown in FIG. 1 is varied between 0 V and −8 V, at 0 V the imager exhibits a non-zero dark count map (DCM) and a zero DCM at −8 V, because each pixel has a zero dark count rate. It should be noted that different voltages applied as the perimeter gate voltage will result in different DCRs, and thus a different DCM for the same chip.

In the context of devising CRPs, the imager is operated in the dark, and a given pixel address represents a single challenge which returns a single response consisting of the number of dark counts that occurred at the selected pixel during the integration time. Thus, a full set of challenge-response pairs may be constructed by querying the entire pixel array or any subset of the entire pixel array.

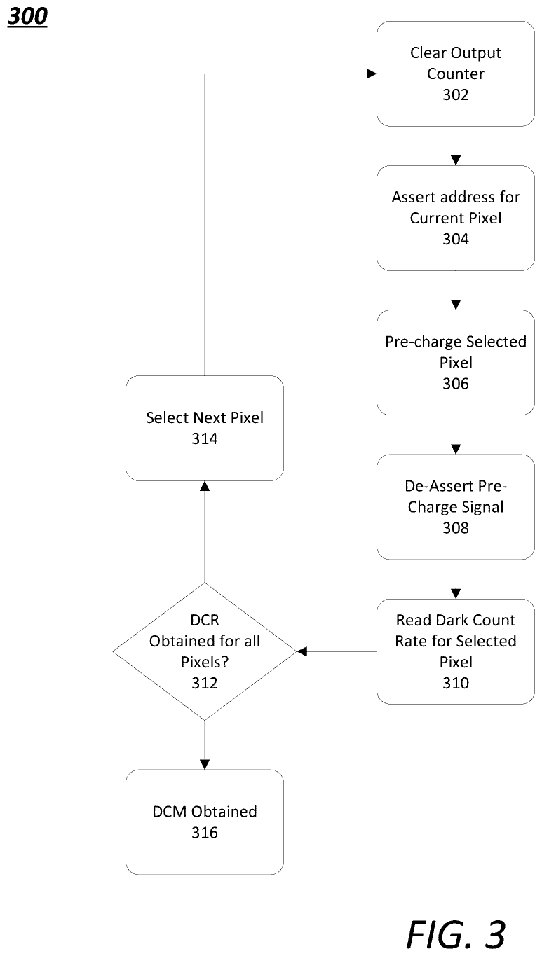

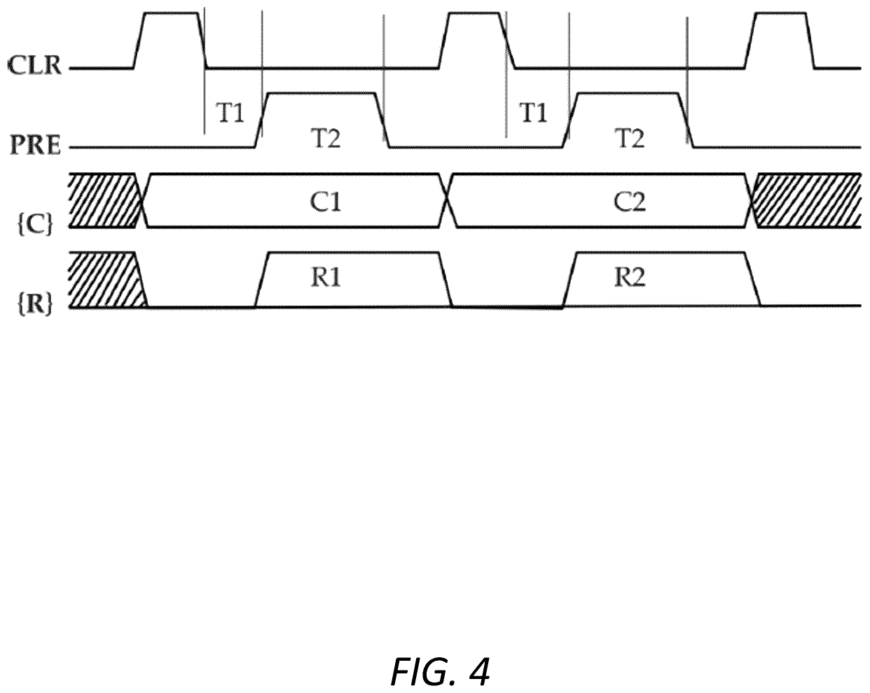

The imager's individual pixels are selected and read out via a random access architecture implemented using column and row selection circuits and a 12-bit addressing scheme. FIG. 3 is a flowchart showing the process for collecting the DCR of each pixel to form the DCM. FIG. 4 shows the timing of the steps. At step 302, the output counter is first cleared (CLR) and, at 304, a pixel address is asserted; this address is the challenge {C}. At step 306, the selected pixel is then pre-charged with a hard reset signal (PRE) in phase T1, and when this signal is de-asserted at step 308 in phase T2, the pixel is readout at step 310 by the output counter, providing a dark count rate R1, which forms the response {R}. At step 312, it is determined if the DCR for all pixels have been obtained, and, if not, the next pixel is selected at step 314 and process steps 302-310 repeat for that pixel. The cycle is repeated to collect a full set of single challenge-response pairs, forming the DCM at step 316.

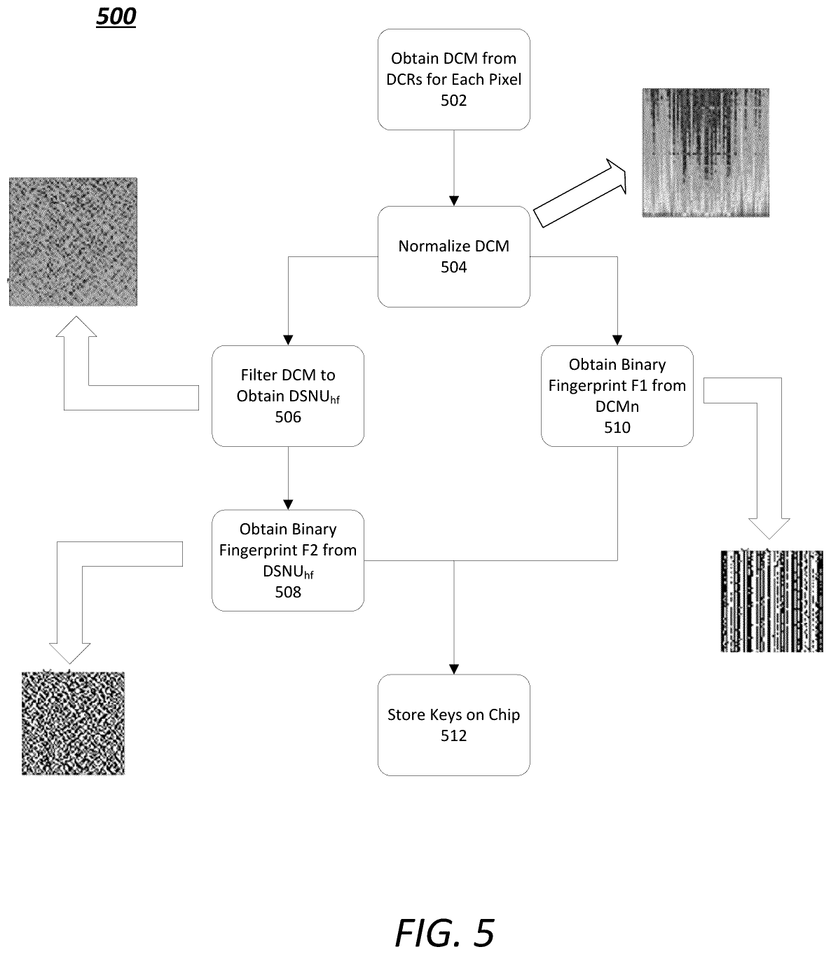

Authentication keys are generated by first obtaining a set of digital fingerprints from the imager's PUF (i.e., from the DCM). A flow chart of the process 500 is shown in FIG. 5. At step 502, the DCM is obtained as the DCR for each pixel. At 504, the DCM is normalized to generate the normalized dark count map DCMn. At step 506, a high-frequency image is extracted from the DCMn using, for example, a Wiener filter and a direct cosine transform to obtain the dark-signal non-uniformity map of the imager (DSNU_{hf}). The DSNU_{hf} represents the variation in the DCR from pixel to pixel, not including readout fixed-pattern noise components, which have relatively low spatial frequency. At step 508, a binary fingerprint F2 is obtained from the DSNU_{hf} using its average value as a threshold. To generate the binary fingerprint, each pixel pᵢⱼ in a block j is compared against the block average (the threshold) and assigned a binary value per Eq. (1).

$${k}_{ij} = \begin{matrix}1 , if {p}_{ij} > mean ( {p}_{j} ) \\ 0 , otherwise\end{matrix} \qquad ( 1 )$$

where kᵢⱼ is the i^{th} bit of the j^{th} key, pᵢⱼ is the response from the pixel in the i^{th} position for the j^{th} challenge and mean (pⱼ) is the average block response.

At step 510, a second binary fingerprint F1 is generated directly from the DCMn, using the same thresholding method. In contrast with F2, fingerprint F1 includes low-frequency fixed pattern noise components associated with the readout chain. These components are less dependent on temperature as they are associated with the readout architecture, whereas fingerprint F2, which is related solely to the DSNU, is strongly dependent on temperature. Thus, a key that combines both F2 and F1 should be resilient to temperature by virtue of F1 and unique from chip-to-chip by virtue of F2. At step 512, the combined fingerprints are stored on the chip.

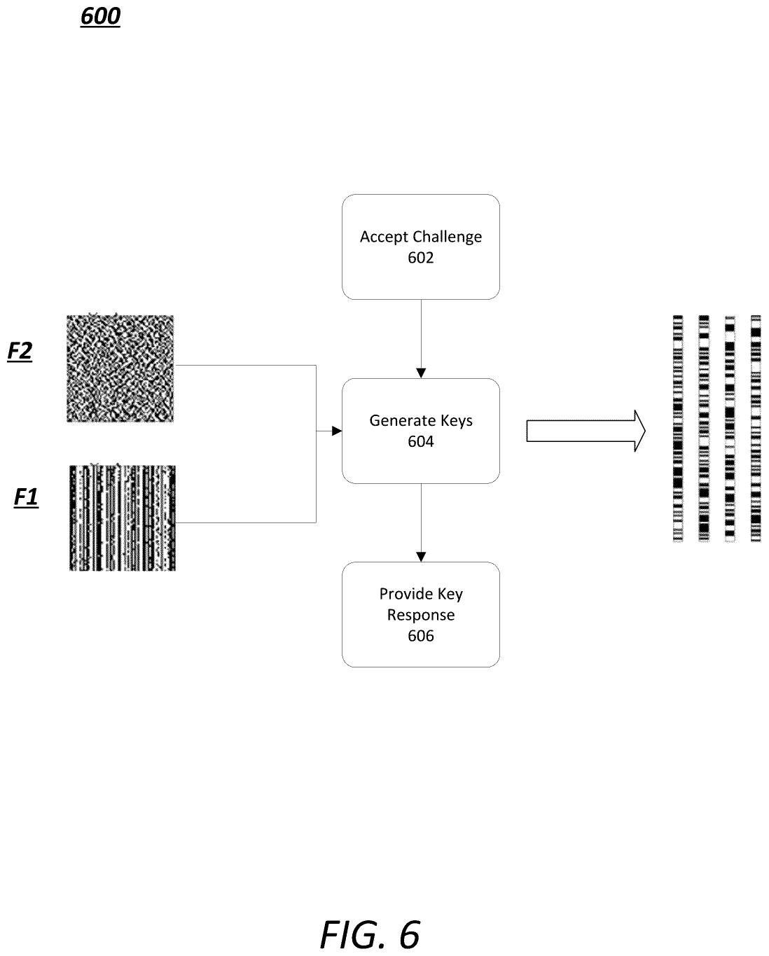

FIG. 6 is a flowchart showing process 600 for generating of the keys in response to a challenge. A challenge may be, for example, a request for the value of a subset of the pixels in the combined fingerprint. At step 602, the challenge is accepted and at step 604, the keys are generated. Keys are generated by reading the values of the pixels in the fingerprint(s). Keys may be generated from each fingerprint independently and combined in any manner, for example, by appending the two keys generated from the two fingerprints. Alternatively, fingerprints F1 and F2 may be combined to create a higher-level fingerprint that is used to generate the keys. At step 606, the keys are returned. Alternate embodiments are also possible, for example, wherein the fingerprints are generated in another way or wherein the DCM is used directly to obtain the keys. These alternate embodiments are intended to be within the scope of the invention.

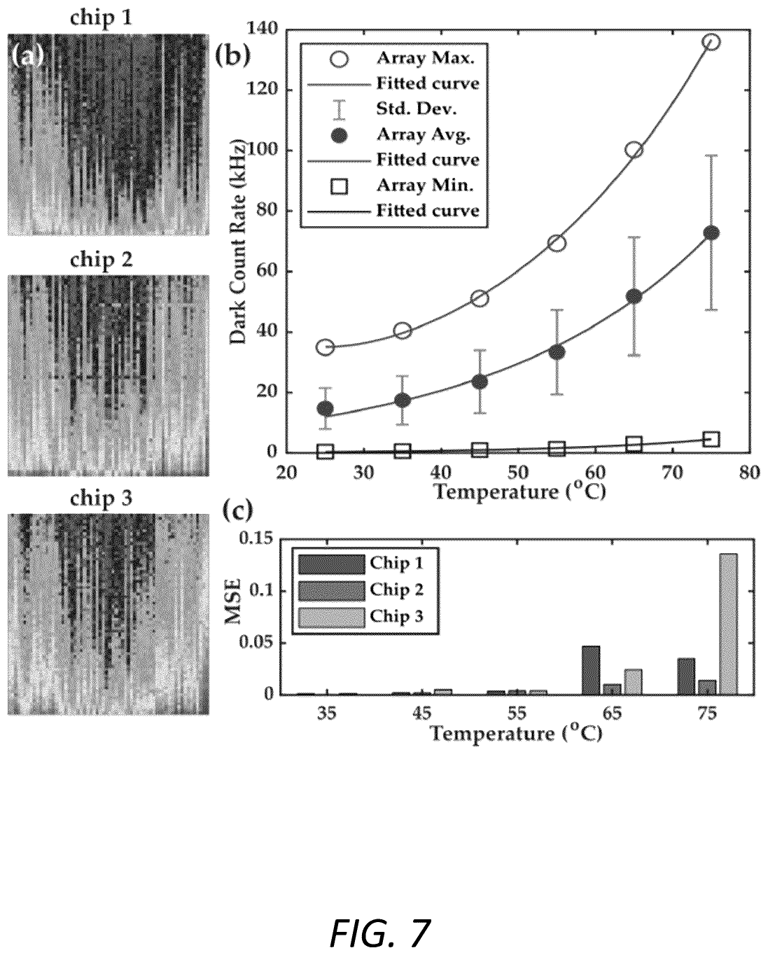

View (a) of FIG. 7 shows the responses collected from three separate test arrays when the set of challenges is the full set of pixel addresses. The responses form a DCM consisting of the room temperature dark counts collected at each pixel during the measurement time. The DCMs obtained with this procedure are normalized and plotted with a color scheme that highlights the differences in value at each pixel and for each chip. The collected DCMs thus form the PUF of the imager, and as expected, because the pixel DCR is random from pixel-to-pixel, the DCMs serve as a unique signature for each chip.

To serve as the basis of a robust authentication scheme, it is desirable that the imager's PUF not drift significantly with temperature. However, temperature changes do affect the DCMs, especially considering that pg-SPADs can exhibit large increases in dark counts at elevated temperatures. This is because a significant portion of the dark count rate of a pg-SPAD is due to thermally generated carriers.

View (b) of FIG. 7 is a graph showing the DCR of the pixel exhibiting the largest value in the array, that of the pixel exhibiting the lowest value, and the average dark count rate of all the 4,096 pixels. The data confirm that there can be a sizable increase in dark count rates across the array as a function of temperature.

To ascertain at which temperature the normalized DCMs start to deviate significantly from their room temperature counterparts, the normalized DCMs' mean square error (MSE) across the temperature range can be computed. Specifically, the MSE measures how similar two normalized DCMs are from one temperature point to another. The data show that significant increases in the MSE occur at and above 55° C., suggesting that the imagers' PUFs deviate from their room temperature values. This suggests that a known challenge would not elicit the same response from the device at room temperature and at temperatures exceeding 55° C. Thus, a strategy is required to be able to generate keys that are resilient to temperature-induced changes in the underlying PUFs.

Although there are many ways to combine fingerprints F1 and F2 to generate the keys, in a preferred embodiment, each row from F1 and F2 is divided into non-overlapping blocks with block length L_{b}.

Based on this, the number of unique binary keys is limited by the challenge length l, yielding 2⁸=256 in this example. Additionally, the difference between two keys kₓ, k_{y} (i.e., a quality metric) is calculated as the normalized Hamming distance (nHD) between the two keys, (kₓ, k_{y}):

$${nHD}_{{k}_{x} , {k}_{y}} = \frac{sum ( xor ( {k}_{x} , {k}_{y} ) )}{{L}_{k}} \leq 1 \qquad ( 2 )$$

Here, xor(⋅) is the exclusive-OR function that returns the logical vector denoting the instances of different bit pairs. All bit mismatches are summed by the sum(⋅) function and normalized by the key length Lₖ. If a generated key is stable, the nHD from itself at another temperature is expected to be 0.

In all other cases (e.g., different chip-same challenge or same chip-different challenge) the nHD is expected to be away from the zero line, ideally around 0.5, with sufficient margin to conclude that a key pair includes different keys.

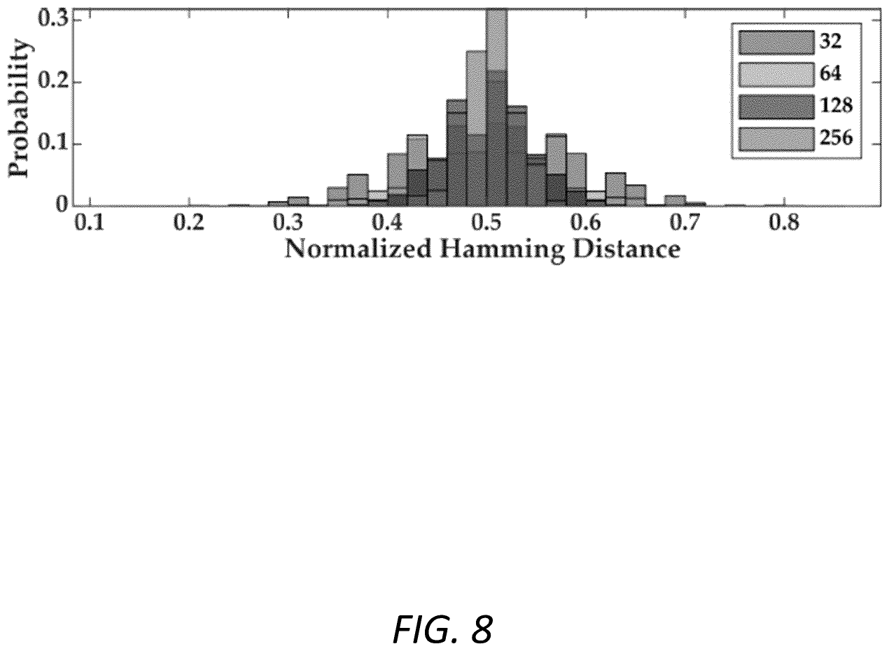

In one exemplary embodiment, all keys were generated by operating the imagers with 0V on the perimeter gate, and keys of different lengths were studied. As shown in FIG. 8, for keys generated from the same board with different challenges, longer bit-length keys were more likely to achieve a tighter spread around a nHD of 0.5, which suggests that longer keys are more likely to achieve a sufficiently large margin from the nHD=0 line.

FIG. 8 shows that a population of short bit-length keys (32 bits) exhibits a large variance around the average nHD (marked by the solid lines through the respective clusters), exacerbated by the increased temperature. In contrast, longer bit-length keys (256 bits) show much lower variance around the two cluster means, even at elevated temperatures. This suggests that the long keys are more stable with temperature increases. This also points out the benefit of mixing keys from two fingerprints and increasing key length. Such an approach provides a means for small scale imagers to generate unique and robust keys without being limited to the small number of intrinsic permutations.

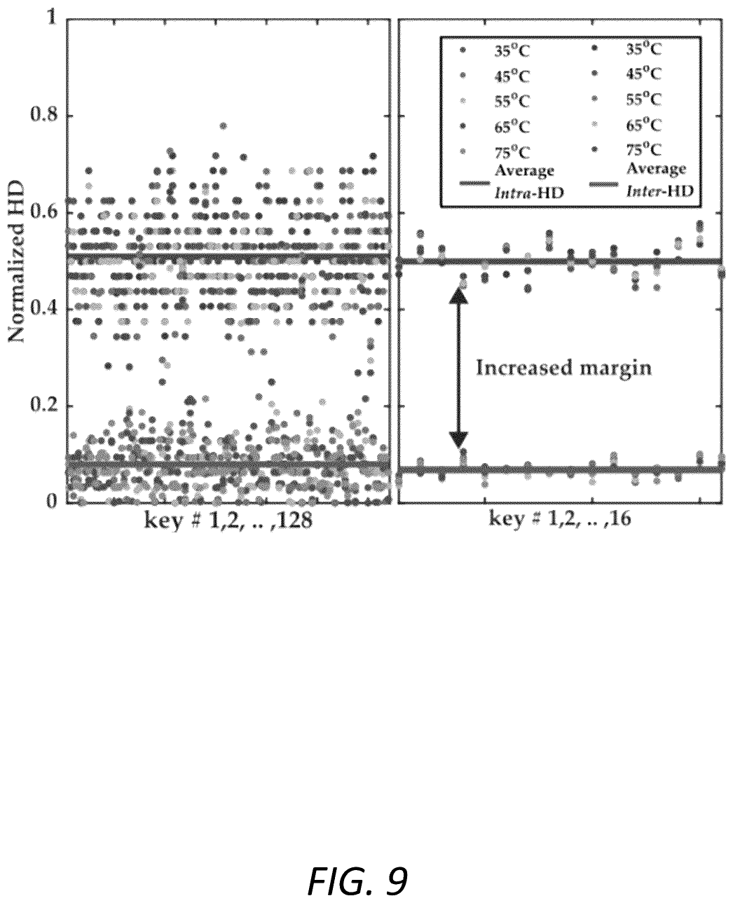

In a second aspect of the invention, the CRP space of the PUF can be increased with the realization that the DCM of the imager varies with the application of different perimeter gate voltages. View (a) of FIG. 9 shows normalized DCMs from three prototype pg-SPAD imager chips compared using a structural similarity index (SSI) to evaluate their sameness. Relative to one another, the SSIs were ˜0.5, which suggests that the DCMs were dissimilar and thus unique fingerprints of the three chips. This is further confirmed by the respective dark count histograms depicted in View (b) of FIG. 9, which show that each chip has a unique dark count distribution. Lastly, View (c) of FIG. 9 shows that, considering a single chip, perimeter gating can alter the DCM, effectively imparting a different fingerprint to the chip as a function of the perimeter gate voltage. This is evidenced by the shift in the distribution of dark counts as perimeter gate voltage is altered. These results thus provide a means for generating chip-specific keys but also, for a single chip, additional PUFs that can be queried, effectively increasing the space of possible challenge-response pairs.

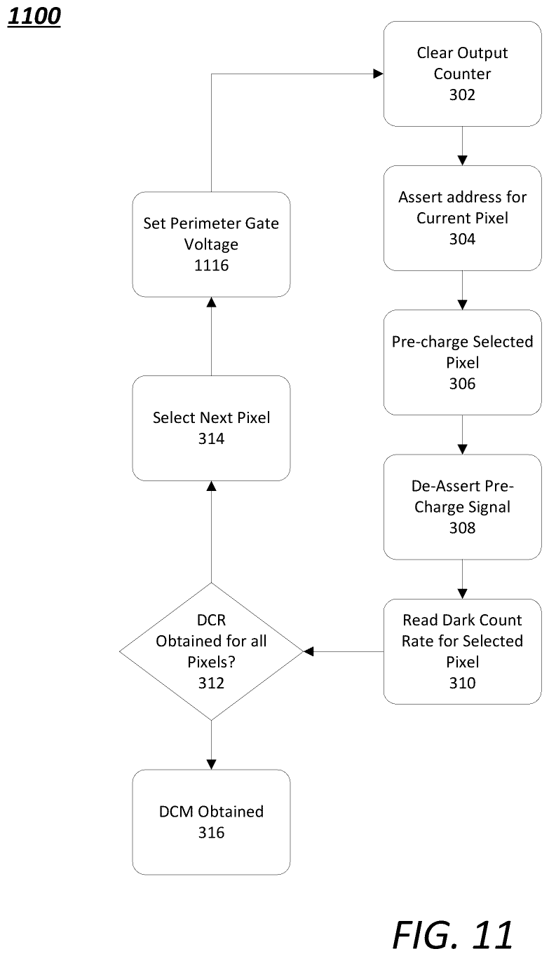

Disclosed herein as the second aspect of the invention, is a method to make the responses of challenge permutations unique. In one embodiment, pixel position-dependent perimeter gate voltages are assigned. This process is shown in flowchart form in FIG. 11, which is identical to process 300 shown in FIG. 3 with the addition of step 1116, wherein the perimeter gate voltage is set individually for each pixel in the array.

As an example, in a given challenge vector, pixels in odd positions of the vector are set at a perimeter gate voltage of 0V while the remaining pixels are set at perimeter gate voltage of 1V. This effectively changes the responses of the permutations because different DCMs are invoked when the perimeter gate voltage is altered. As a result, out of L! permutated challenges,

$$L ! - {( \frac{L}{2} ! )}^{2} \approx L !$$

(assuming L>6) sequences result in unique responses, even after remapping. Using this method, the CRP space can be increased to an even greater number because perimeter gating is analog, which means it can reconfigure the PUF to many more states.

In alternate embodiments, process 1100 of FIG. 11 may be repeated multiple times for the same chip to produce multiple fingerprints. Challenges may then be accepted and may indicate, on a pixel-by-pixel basis, the fingerprint from which to draw the value for the pixel for the response.

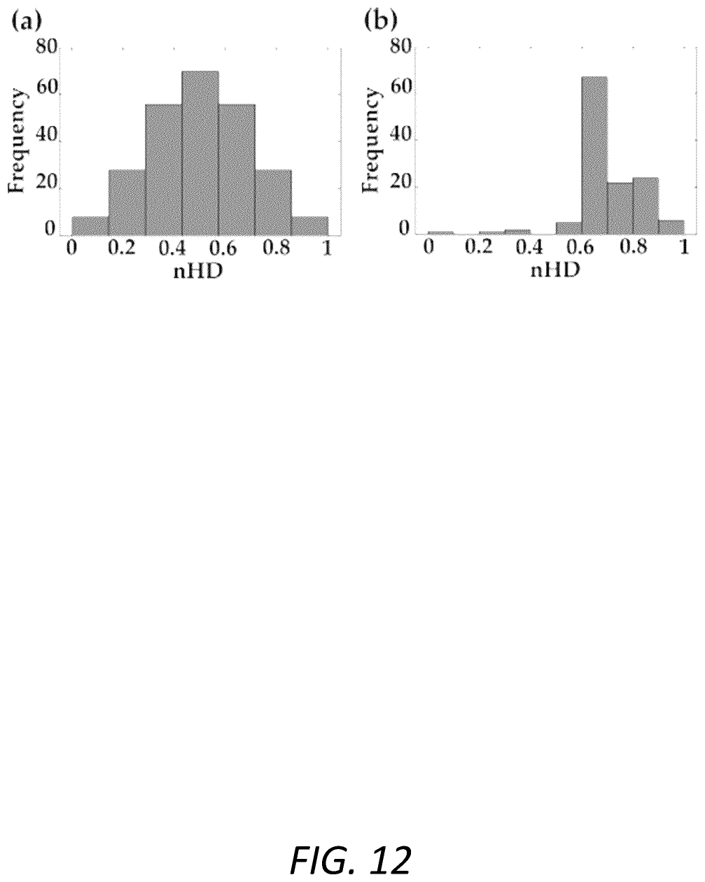

View (a) of FIG. 12 is a histogram showing the nHD distribution for all possible 8-bit keys with respect to a randomly selected reference key. As expected, the average nHD is 0.5, with some keys being very close to the reference key. View (b) of FIG. 12 shows the histogram for the keys generated from the disclosed method for increasing the CRP space from 128 permutated challenges. The resulting distribution of nHDs shows a shift towards an nHD of 1, suggesting that most of the keys are distinct from the reference key, which confirms that permutations of the same block need not be discarded at the same rate as that of the state-of-the-art.

In practice, a chip manufacturer, or other third party, may store one or more signatures for each manufactured chip. A user may issue a challenge to the chip comprising any subset of the pixel array (or the entire array) and will receive a response based on one or more signatures. The received response may them be verified by the third party as the expected response from the specified challenge.

Different schemes may be practiced for increasing the CRP space using the perimeter gate voltage method. For example, different perimeter gate voltages may be applied to different subsets of pixels or the perimeter gate voltage may be varied on a pixel-by-pixel basis. Many variations of the application of the perimeter gate voltage to the individual pixels can be imagined and all such permutations are intended to be within the scope of the invention. By using various permutations varying the perimeter gate voltage, multiple DCMs may be created for each pixel array and keys may be generated using pixels from a combination of the DCMs. Responses to challenges may use individual pixels from different key sets.

Disclosed here is the use of a perimeter-gated SPAD imager as a PUF-based key generator. The dark count maps of the imager can be used reliably to generate authentication keys that are stable across a wide temperature range. Furthermore, the keys are different across multiple sensors even when the same challenge is used. Lastly, perimeter gating can be used to reduce the dark counts as a means to change or obfuscate the chip fingerprints generated from the PUF and to increase the challenge-response pair space.

As would be realized by those of skill in the art, specific exemplary embodiments disclosed herein, including specific equipment used, specific algorithms and specific visual stimuli are provided as exemplary embodiments and the invention is not meant to be limited thereby. Modifications and variations of the examples used herein are intended to be within the scope of the invention. For example, the design of the pg-SPAD circuit described herein is provided only as an exemplary circuit. Additionally, the technique for generating multiple dark count maps and multiple key sets can be changed using various permutations of variation of the perimeter gate voltage of the pg-SPAD. The intended scope of the invention is given by the following claims:

1. A method for determining a physically unclonable function in a pixel array comprising:
determining a dark count map for the array comprising a dark count rate for each pixel in the array when the array is exposed to darkness; and
using the dark count map as a signature to generate a set of keys.

2. The method of claim 1 wherein the dark count rate for each pixel is a number of dark counts that occurred at that pixel during a predetermined integration time.

3. The method of claim 2 where a dark count is a number of events that occur resulting from a noise process and not related to photon generation.

4. The method of claim 1 further comprising:
normalizing the dark count map;
creating one or more fingerprints from the normalized dark count map; and
combining the one or more fingerprints to obtain a set of keys.

5. The method of claim 4 wherein at least one of the fingerprints is a first fingerprint comprising a binarization of the normalized dark count map.

6. The method of claim 5 wherein a value of a pixel in the first fingerprint is 1 if the value of the pixel in the normalized dark count map exceeds a mean value of all pixels in the normalized dark count map and is 0 otherwise.

7. The method of claim 4 further comprising:
extracting a high frequency image from the normalized dark count map.

8. The method of claim 7 wherein the high frequency image is created by applying a Wiener filter and a direct cosine transform to the normalized dark count map.

9. The method of claim 7 wherein at least one of the fingerprints is a second fingerprint comprising a binarization of the high frequency image.

10. The method of claim 9 wherein a value of a pixel in the second fingerprint is 1 if the value of the pixel in the high frequency image exceeds a mean value of all pixels in the high frequency image and is 0 otherwise.

11. The method of claim 4 wherein the pixel array is queried using a challenge query and a response to the challenge query is provided based on the set of keys.

12. The method of claim 11 wherein the challenge query consists of the entire pixel array or any subset of the entire pixel array.

13. The method of claim 12 wherein a third party is privy to the set of keys for the pixel array and further wherein a response to a challenge query may be verified by the third party.

14. The method of claim 13 wherein each pixel in the array is a perimeter-gated single photon avalanche diode and further wherein a perimeter gate voltage of each pixel is held constant during the creation of the dark count map.

15. The method of claim 14 wherein the same perimeter gate voltage is applied to each pixel.

16. The method of claim 14 wherein different subsets of pixels have different perimeter gate voltages applied thereto.

17. The method of claim 14 wherein the perimeter gate voltage varies from pixel-to-pixel.

18. The method of claim 14 wherein one or more dark count maps are created for the pixel array by varying the perimeter gate voltage on a pixel-by-pixel basis for each dark count map.

19. The method of claim 18 wherein a set of keys is generated from each of the one or more dark count maps.

20. The method of claim 19 wherein a challenge comprising a challenge vector is directed to individual pixels in any of the one or more key sets.

21. The method of claim 20 wherein a response to the challenge comprises a value of individual pixels in the one of more key sets identified by the challenge vector.

22. A method for enlarging the challenge-response space for a physically unclonable function in a pixel array comprising:
determining one or more dark count maps for the array, each dark count map comprising a dark count rate for each pixel in the array when the array is exposed to darkness; and
using the one or more dark count maps as signatures to generate a set of keys;
wherein each pixel in the array has perimeter gate voltage applied thereto and further wherein the perimeter gate voltage varies from pixel-to-pixel for each dark count map.

23. The method of claim 22 wherein a challenge comprising a challenge vector is directed to individual pixels in any of the one or more dark count maps.

24. The method of claim 23 wherein a response to the challenge comprises a value of individual pixels in the one of more dark count maps identified by the challenge vector.

25. The method of claim 22 wherein a set of keys is generated from each of the one or more dark count maps.

26. The method of claim 25 wherein a challenge comprising a challenge vector is directed to individual pixels in any of the one or more key sets.

27. The method of claim 26 wherein a response to the challenge comprises a value of individual pixels in the one of more key sets identified by the challenge vector.

28. An imager chip, comprising:
an array of pixels, the array including a set of pixels, each pixel in the set having a dark count rate; and
one or more physically unclonable functions, the one or more physically-unclonable functions being dependent on the dark rate count for each pixel.

29. The imager chip of claim 28 wherein each pixel includes a perimeter-gated photodiode, the perimeter-gated photodiode including a gate terminal.

30. The imager chip of claim 29 wherein the one or more physically unclonable functions is alterable by altering a voltage applied to the gate terminal.

31. The imager chip of claim 29 wherein the perimeter-gated photodiode is a perimeter-gated single-photon avalanche diode (pg-SPAD).

32. The imager chip of claim 28, wherein the one more physically unclonable functions is concealable using the gate terminal.

33. The imager chip of claim 28 wherein the one or more physically-unclonable functions comprises one or more fingerprints stored on the imager chip.
